(19) United States
(12) Patent Application Publication
(10) Pub. No.: US 2026/0249930 A1
(43) Pub. Date: Aug. 27, 2026

(54) BED EXTENDER ASSEMBLIES FOR VEHICLES

(71) Applicant: Toyota Jidosha Kabushiki Kaisha, Aichi-Ken (JP)

(72) Inventors: Hiroaki Yokoi, Ann Arbor, MI (US); Benjamin D. Jimenez, Ann Arbor, MI (US); Matthew McMullen, Novi, MI (US)

(73) Assignee: Toyota Jidosha Kabushiki Kaisha, Aichi-Ken (JP)

(21) Appl. No.: 19/060,291

(22) Filed: Feb. 21, 2025

(51) Int. Cl. B62D 33/02; B62D 33/027

(52) U.S. Cl. CPC B62D 33/0207; B62D 33/0273

(57) ABSTRACT

A bed extender assembly for a vehicle having a floor that defines a recess and a pair of bed side walls. The bed extender assembly includes a bed extender having a main wall, a first side wall, and a second side wall. The main wall extends between a first end and a second end. The first side wall extends from the first end of the main side wall and the second side wall extends from the second end of the main wall to define a generally U-shape. The bed extender is rotatably coupled to the pair of bed side walls to rotate between a use position and a stowed position. In the stowed position, the main wall is at least partially received within the recess of the floor.

### TECHNICAL FIELD

The present specification generally relates to bed extender assemblies for vehicles and, more specifically, bed extender assemblies that are integrated with the vehicles.

### BACKGROUND

Vehicles having a bed for the storage of cargo (i.e., pickup trucks) are a popular configuration for many vehicle operators. The bed provides a large surface area and volume for the storage of cargo. In certain situations, the bed does not provide sufficient storage (e.g., items longer than the bed or excessive cargo items that occupy more space than the allotted by the bed). In those situations, the tailgate may be lowered to extend the surface area of the bed. However, with the tailgate lowered the bed does not have a barrier to the rear of the vehicle to prevent items from sliding, rolling, or otherwise falling out of the bed of the vehicle. Bed extender have been used to form a barrier around the perimeter of the lowered tailgate. However, the bed extenders rotate 180 degrees into the bed when stowed, forming a wall that bisects the bed and limits the use of the bed when the bed extenders are not in use.

Accordingly, a need exists for bed extender assemblies that are integrated with the vehicles.

### SUMMARY

In one embodiment, a bed extender assembly is used with a vehicle having a floor that defines a recess and a pair of bed side walls. The bed extender assembly includes a bed extender having a main wall, a first side wall, and a second side wall. The main wall extends between a first end and a second end. The first side wall extends from the first end of the main side wall and the second side wall extends from the second end of the main wall to define a generally U-shape. The bed extender is rotatably coupled to the pair of bed side walls to rotate between a use position and a stowed position. In the stowed position, the main wall is at least partially received within the recess of the floor.

In another embodiment, a vehicle may include a bed. The bed may include a pair of bed side walls each extending in a vehicle vertical direction and a floor extending in a vehicle lateral direction between the pair of bed side walls. The floor and the pair of bed side walls define a storage space. The floor defines a recess opening into the storage space. The vehicle may include a bed extender assembly. The bed extender assembly may include a bed extender having a main wall, a first side wall, and a second side wall. The main wall extends between a first end and a second end. The first side wall extends from the first end of the main side wall and the second side wall extends from the second end of the main wall to define a generally U-shape. The bed extender is rotatably coupled to the pair of bed side walls to rotate between a use position and a stowed position. In the stowed position, the main wall is at least partially received within the recess of the floor.

In another embodiment, a vehicle may include a bed. The bed may include a first bed side wall and a second bed side wall each extending in a vehicle vertical direction and a floor extending in a vehicle lateral direction between the first bed side wall and the second bed side wall. The vehicle may include a tailgate coupled to the floor of the bed and moveable between an open position in which the tailgate is coplanar with the floor and a closed position in which the tailgate to transverse to the floor. The vehicle may include a bed extender assembly. The bed extender assembly may include a bed extender rotatable between a use position and a stowed position when the tailgate is in the open position. The bed extender may include a main wall extending between a first end and a second end, a first side wall extending from the first end of the main wall to a first distal surface, and a second side wall extending from the second end of the main wall to a second distal surface. The main wall, the first side wall, and the second side wall form a lower surface configured to face the tailgate of the vehicle in the use position and an upper surface opposite the lower surface and configured to face away from the tailgate in the use position. The bed extender assembly may include a first rotational joint mounted to the first side wall adjacent a first corner defined by the first distal surface and the upper surface and mounted to the first bed side wall of the bed and a second rotational joint mounted to the second side wall adjacent a second corner defined by the second distal surface and the upper surface and mounted to the second bed side wall of the bed. The first rotational joint and the second rotational joint allow rotation of the bed extender relative to the bed between the use position and the stowed position. The first bed side wall, the second bed side wall, and the floor define a storage space and the floor defines a recess opening into the storage space. The main wall is disposed in the recess of the floor in the stowed position to allow use of the storage space.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle having a bed, a tailgate disposed in an open position, and a bed extender disposed in a use position, according to one or more embodiments shown and described herein;

FIG. 2 schematically depicts a perspective view of the vehicle of FIG. 1, with the tailgate disposed in the open position and the bed extender disposed in an installation position, according to one or more embodiments shown and described herein;

FIG. 3 schematically depicts a perspective view of the vehicle of FIG. 1, with the tailgate disposed in the open position and the bed extender disposed in a stowed position, according to one or more embodiments shown and described herein;

FIG. 4 schematically depicts a perspective view of the vehicle of FIG. 1, with the tailgate disposed in a closed position and the bed extender disposed in the stowed position, according to one or more embodiments shown and described herein;

FIG. 5 schematically depicts a top plan view of the vehicle of FIG. 1, with the tailgate disposed in the closed position and the bed extender disposed in the stowed position, according to one or more embodiments shown and described herein;

FIG. 6 schematically depicts a top plan view of the vehicle of FIG. 1, with the tailgate disposed in the open position and the bed extender disposed in the use position, according to one or more embodiments shown and described herein;

FIG. 7 schematically depicts a partial perspective view of the vehicle of FIG. 1, with the tailgate disposed in the open position and the bed extender disposed in the stowed position, according to one or more embodiments shown and described herein;

FIG. 8 schematically depicts a partial perspective and cross-sectional view of the vehicle of FIG. 1, showing the bed extender disposed in a recess in the stowed position, according to one or more embodiments shown and described herein;

FIG. 9 schematically depicts a top plan view of a first rotational joint mounted to the bed and the bed extender of FIG. 1, according to one or more embodiments shown and described herein;

FIG. 10 schematically depicts a perspective view of the first rotational joint of FIG. 9 showing a receptacle and a stud, according to one or more embodiments shown and described herein; and

FIG. 11 schematically depicts a perspective view of the first rotational joint of FIG. 9 showing the receptacle and the stud, with the stud oriented in the installation position of the bed extender, according to one or more embodiments shown and described herein.

### DETAILED DESCRIPTION

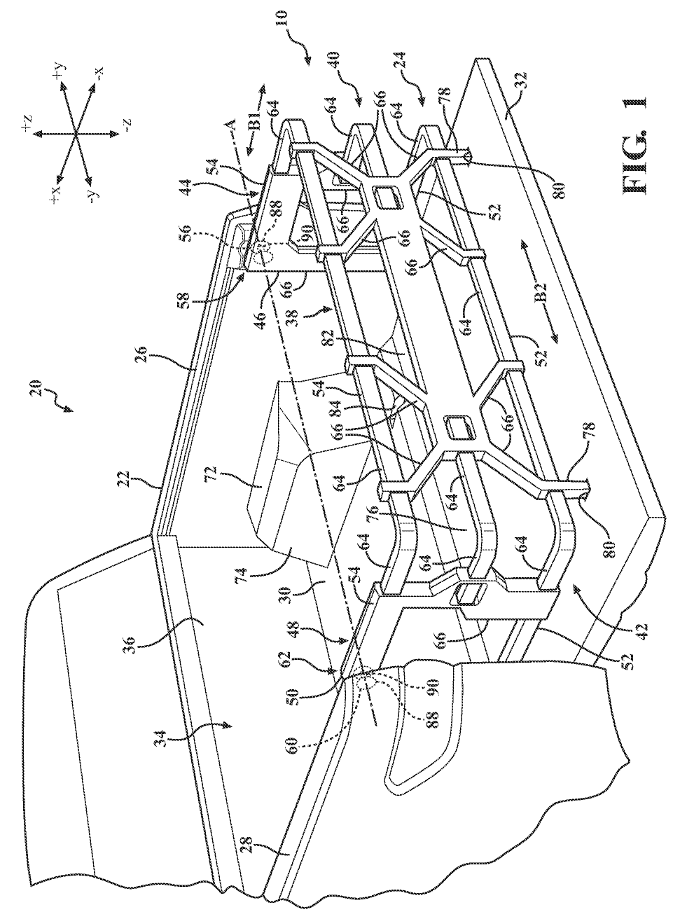

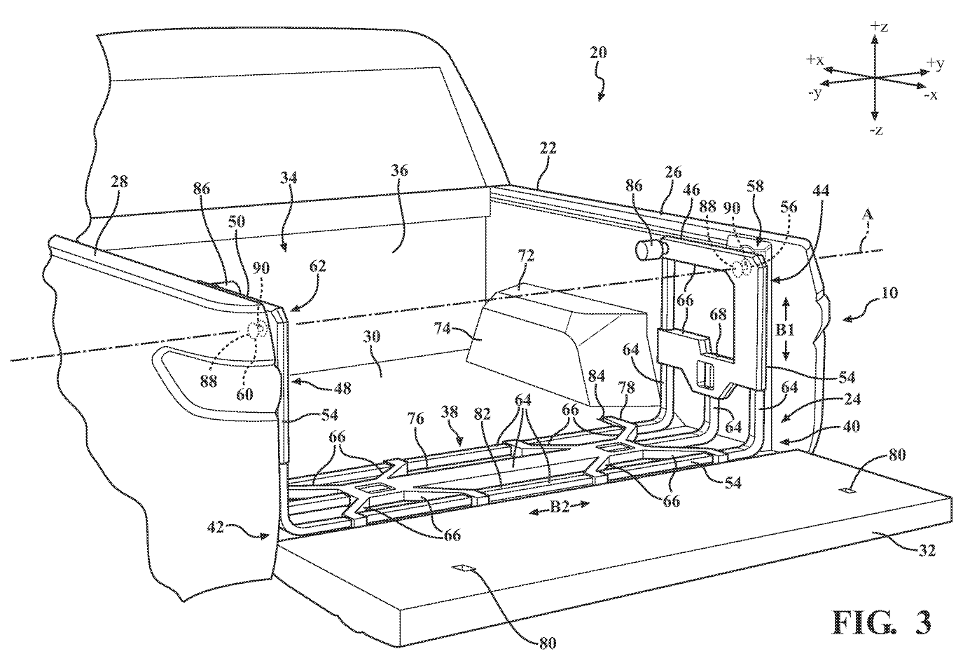

FIGS. 1-3 generally depict a bed extender assembly for a vehicle having a floor that defines a recess and a pair of bed side walls. The bed extender assembly includes a bed extender having a main wall, a first side wall, and a second side wall. The main wall extends between a first end and a second end. The first side wall extends from the first end of the main side wall and the second side wall extends from the second end of the main wall to define a generally U-shape. The bed extender is rotatably coupled to the pair of bed side walls to rotate between a use position (see FIG. 1) and a stowed position (see FIG. 3). In the stowed position, the main wall is at least partially received within the recess of the floor.

Previous bed extenders have been used to form a barrier around the perimeter of a tailgate in an open position. However, the bed extenders rotate 180 degrees into the bed when stowed, forming a wall that bisects the bed and limits the use of the bed. The embodiments described herein provide the recess in the floor of the vehicle that at least partially receives the main wall of the bed extender. In doing so, storage space within the bed is unencumbered, allowing for full use of the bed in the stowed position. Various embodiments and benefits of the bed extender and the vehicle will be described in more detail herein.

As used herein, the term “vehicle longitudinal direction” refers to the forward-rearward direction of the vehicle (i.e., in the +/- X direction of the coordinate axes depicted in FIG. 1). The term “vehicle lateral direction” refers to the cross-vehicle direction (i.e., in the +/- Y direction of the coordinate axes depicted in FIG. 1), and is transverse to the vehicle longitudinal direction. The term “vehicle vertical direction” refers to the upward-downward direction of the vehicle (i.e., in the +/- Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIGS. 1-3, a vehicle 20 having a bed 22 (e.g., a pickup truck) is provided with a bed extender assembly 10 having a bed extender 24, in accordance with one or more embodiments of the present disclosure. The bed 22 includes a pair of bed side walls, with one of the pair of bed side walls referred to as a first bed side wall 26 and the other one of the pair of bed side walls referred to as a second bed side wall 28. Each of the first bed side wall 26 and the second bed side wall 28 extend in the vehicle vertical direction Z. The bed 22 further includes a floor 30 extending in the vehicle lateral direction Y between the first bed side wall 26 and the second bed side wall 28. The first bed side wall 26 and the second bed side wall 28 also extend in the vehicle longitudinal direction X such that each of the first bed side wall 26 and the second bed side wall 28 have a substantially planar configuration. The floor 30 also extends in the vehicle longitudinal direction X such that the floor 30 has a substantially planar configuration. Accordingly, the first bed side wall 26, the second bed side wall 28, and the floor 30 collectively form a U-shape configuration that extends in the vehicle longitudinal direction X.

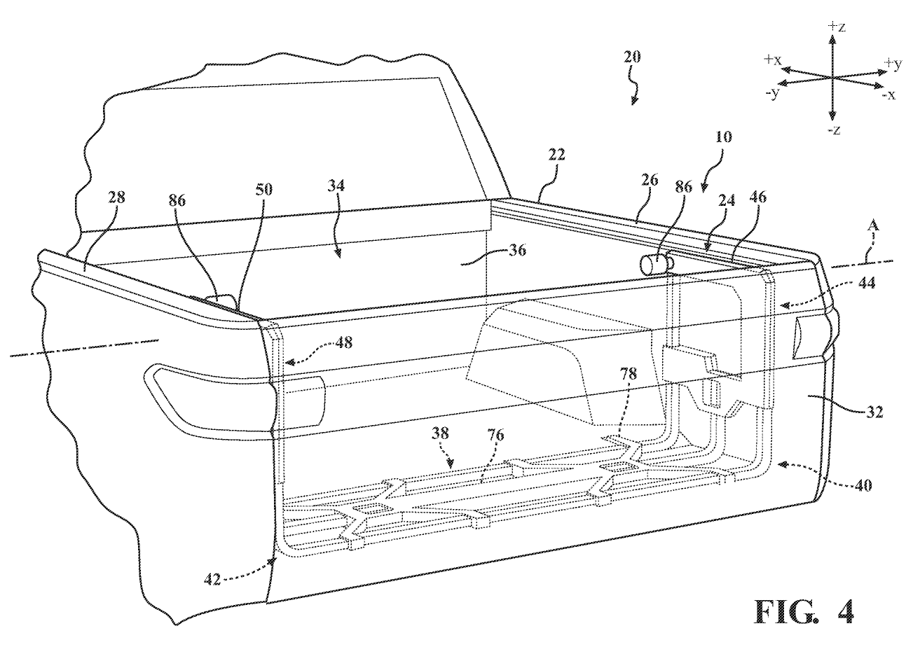

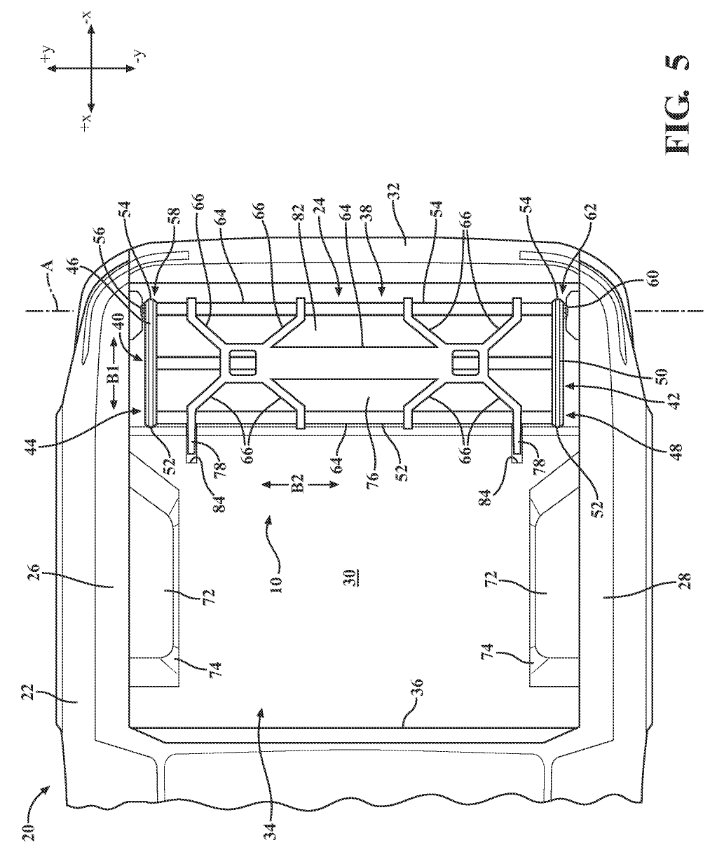

The vehicle 20 further includes a tailgate 32 coupled to the bed 22 and moveable between an open position (see FIGS. 1-3 and 6-8) in which the tailgate 32 is coplanar with the floor 30 and a closed position (see FIGS. 4 and 5) in which the tailgate 32 is transverse to the floor 30. More specifically, the tailgate 32 is rotatable relative to the floor 30 between the open position and the closed position. The tailgate 32 is rotatably coupled to the first bed side wall 26 and the second bed side wall 28 for movement between the open position and the closed position.

As shown in FIGS. 1-6, the first bed side wall 26, the second bed side wall 28, and the floor 30 define a storage space 34. The storage space 34 is a volume in which cargo may be disposed for transport by the vehicle 20. The storage space 34 is typically open above the first bed side wall 26 and the second bed side wall 28. However, the storage space 34 may be closed off by modular enclosure (e.g., a tonneau cover, a bed cap, etc.) The tailgate 32 forms a barrier for the storage space 34 in the vehicle longitudinal direction X to the rear of the vehicle 20 when disposed in the closed position. More specifically, the tailgate 32 prevents the cargo from sliding, rolling, or otherwise falling out of the bed 22 toward the rear of the vehicle 20.

The vehicle 20 may further include a front wall 36 disposed opposite the tailgate 32 and mounted to each of the first bed side wall 26, the second bed side wall 28, and the floor 30. The front wall 36 forms a barrier for the storage space 34 in the vehicle longitudinal direction X to the front of the vehicle 20, which prevents the cargo from sliding, rolling, or otherwise falling out of the bed 22 toward the front of the vehicle 20. The front wall 36 may be formed of one or more components that are separate from the rest of the vehicle 20. In another embodiment, the front wall 36 is integrated into a passenger compartment of the vehicle 20.

The cargo is disposed on the floor 30 of the bed 22 within the storage space 34. In certain situations, it may be desirable to increase the surface area of the floor 30. For example, some cargo may be longer than the floor 30 of the bed 22 or the amount of cargo may overfill the storage space 34 and require additional space. Lowering the tailgate 32 to the open position effectively extends the length of the floor 30, providing additional storage space for the cargo. However, with the tailgate 32 in the open position, the bed 22 is not enclosed to the rear of the vehicle 20. As such, cargo may slide, roll, or otherwise fall out of the rear of the vehicle 20. The bed extender 24 serves as a barrier to extend the storage space 34 to include the volume over the tailgate 32 in the open position.

While the vehicle 20 shown in FIG. 1 is configured as a pickup truck, the bed extender 24 may be used in any configuration of a vehicle (e.g., a passenger car, a van, a sport-utility vehicle, a crossover vehicle, airplane, boat, etc.) and may be used in any suitable location within the vehicle 20, including configuration specific locations (e.g., in the trunk of a passenger vehicle).

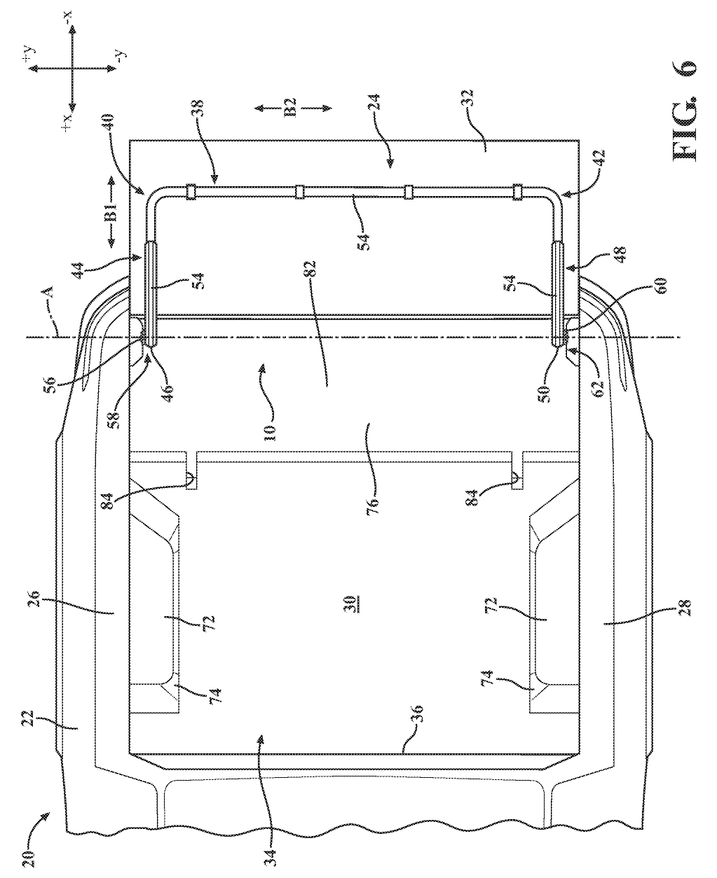

The bed extender 24 is rotatable between a use position (see FIGS. 1 and 6) and a stowed position (see FIGS. 3-5 and 7-8) when the tailgate 32 is in the open position. As shown in FIGS. 1-3 and 6, the bed extender 24 includes a main wall 38 extending between a first end 40 and a second end 42, a first side wall 44 extending from the first end 40 of the main wall 38 to a first distal surface 46, and a second side wall 48 extending from the second end 42 of the main wall 38 to a second distal surface 50.

The main wall 38, the first side wall 44, and the second side wall 48 form a lower surface 52 configured to face the tailgate 32 in the use position (with the tailgate 32 in the open position) and an upper surface 54 opposite the lower surface 52 and configured to face away from the tailgate 32 in the use position. The first side wall 44 is rotatably mounted to the first bed side wall 26 and the second side wall 48 is rotatably mounted to the second bed side wall 28. More specifically, the bed extender assembly 10 includes a first rotational joint 56 mounted to the first side wall 44 adjacent a first corner 58 defined by the first distal surface 46 and the upper surface 54 and mounted to the first bed side wall 26 of the bed 22. The bed extender assembly 10 further includes a second rotational joint 60 mounted to the second side wall 48 adjacent a second corner 62 defined by the second distal surface 50 and the upper surface 54 and mounted to the second bed side wall 28 of the bed 22. The first rotational joint 56 and the second rotational joint 60 rotatably couples the bed extender 24 to allow rotation relative to the bed 22 between the use position and the stowed position.

The first side wall 44 and the second side wall 48 are rotatably mounted to the first bed side wall 26 and the second bed side wall 28, respectively, adjacent the tailgate 32. More specifically, the first rotational joint 56 and the second rotational joint 60 are mounted to the first bed side wall 26 and the second bed side wall 28, respectively, adjacent the tailgate 32. Furthermore, each of the first bed side wall 26 and the second bed side wall 28 includes a top surface that is disposed opposite the floor 30. The first rotational joint 56 is mounted to the first bed side wall 26 adjacent the top surface of the first bed side wall 26. Likewise, the second rotational joint 60 is mounted to the second bed side wall 28 adjacent the top surface of the second bed side wall 28. The disposition of the first rotational joint 56 and the second rotational joint 60 adjacent the tailgate 32 allows the bed extender 24 to extend onto the tailgate 32 in the use position with a reduced length of the first side wall 44 and the side wall when compared to being mounted further inward from the tailgate 32. Moreover, the disposition of the first rotational joint 56 and the second rotational joint 60 adjacent the tailgate 32 and adjacent the top surfaces allows the bed extender 24 to rotate into the stowed position, as will be described in greater detail below.

Both the first side wall 44 and the second side wall 48 extend from the main wall 38 in a first direction B1. The main wall 38 extends in a second direction B2 that is orthogonal to the first direction B1. In the use position, the first direction B1 is aligned with the vehicle longitudinal direction X and the second direction B2 is aligned with the vehicle lateral direction Y. In the stowed position, the first direction B1 is aligned with the vehicle vertical direction Z and the second direction B2 is aligned with the vehicle lateral direction Y. Each of the first side wall 44 and the second side wall 48 may have a planar configuration and are disposed parallel to one another. Moreover, the planar configurations of the first side wall 44 and the second side wall 48 are substantially parallel to the first bed side wall 26 and the second bed side wall 28. The main wall 38 may also have a planar configuration. As such, the first side wall 44, the second side wall 48, and the main wall 38 may have a generally U-shaped configuration that forms a perimeter extending from the first bed side wall 26 and the second bed side wall 28 around the tailgate 32 when the tailgate 32 is in the open position and the bed extender 24 is in the use position. When the bed extender 24 is in the stowed position, generally U-shaped configuration of the bed extender 24 results in the first side wall 44, the second side wall 48, and the main wall 38 extending along the first bed side wall 26, the second bed side wall 28, and the floor 30 respectively, such that the bed extender 24 is nested within the bed 22 and storage space 34 remains available for use by the cargo.

The main wall 38, the first side wall 44, and the second side wall 48 may have a space frame configuration. More specifically, in the embodiment shown in FIGS. 1-3, each of the main wall 38, the first side wall 44, and the second side wall 48 may include a plurality of rails 64 extending horizontally and a plurality of braces 66 extending between the rails 64 to position and support the plurality of rails 64. In other embodiments, the main wall 38, the first side wall 44, and the second side wall 48 may have a monolithic configuration. It is to be appreciated that the main wall 38, the first side wall 44, and the second side wall 48 may have any suitable configuration for forming a barrier along the tailgate 32.

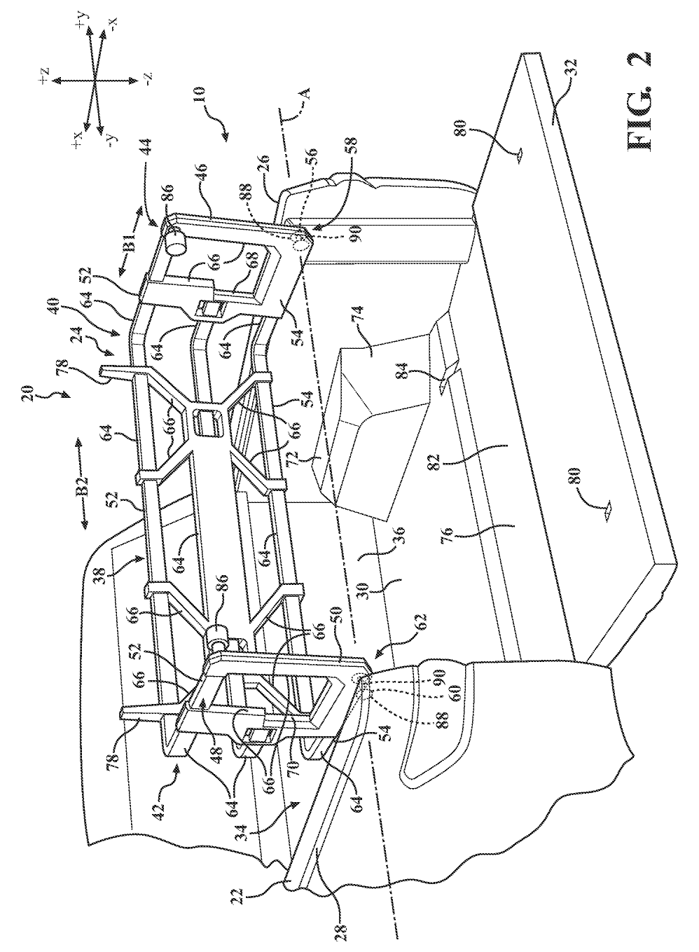

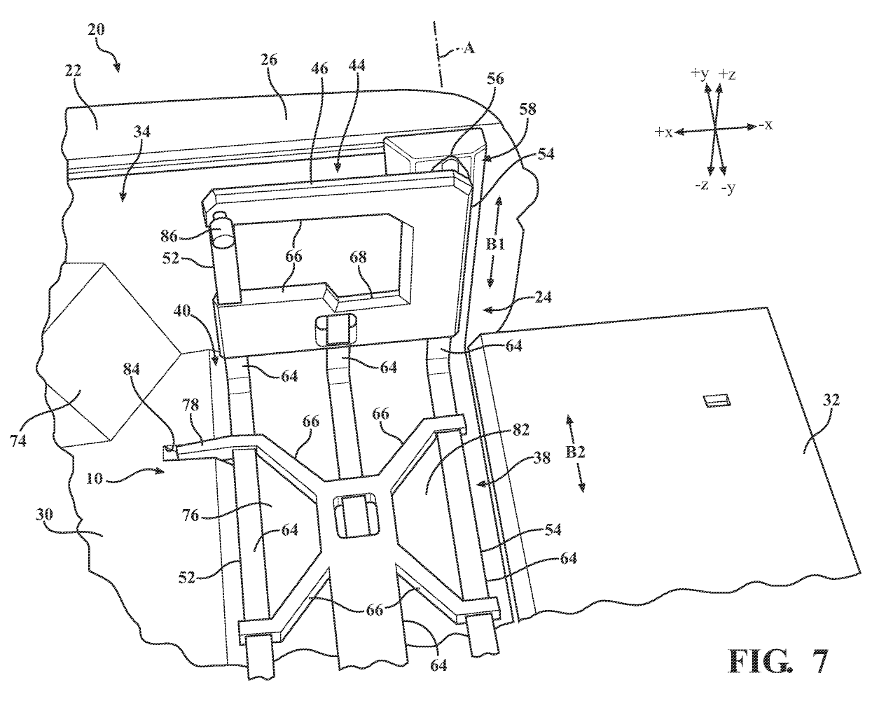

With reference to FIG. 2, one of the braces 66 of the first side wall 44 may define a first groove 68 and one of the braces 66 of the second side wall 48 may define a second groove 70. Both the first groove 68 and the second groove 70 open in the vehicle vertical direction Z when the bed extender 24 is in the stowed position. The first groove 68 and the second groove 70 are aligned in the vehicle lateral direction Y. The first groove 68 and the second may each be sized to receive and support a board that extends in the vehicle lateral direction Y (e.g., 2x4 lumber). With reference to FIGS. 3 and 7, the first groove 68 and the second groove 70 may be positioned in the vehicle vertical direction Z such that the board is substantially flush with a top surface 72 of each of a pair of wheel wells 74 that extend above the floor 30 of the bed 22. The top surface 72 of each of the wheel wells 74 and the board may support a large object that extends in the vehicle longitudinal direction X and the vehicle lateral direction Y across the bed 22 (e.g., plywood, drywall, etc.)

In the embodiment shown in FIGS. 1-6, both of the first rotational joint 56 and the second rotational joint 60 are disposed along, and rotatable about, an axis A. Said differently, the first rotational joint 56 and the second rotational joint 60 are collinear, with the axis A extending in the vehicle lateral direction Y. As such, the bed extender 24 rotates about the axis A and the vehicle lateral direction Y between the use position and the stowed position. It is to be appreciated that in other embodiments the first rotational joint 56 may rotate about an axis that is separate from an axis of the second rotational joint 60 (e.g., the first rotational joint 56 and the second rotational joint 60 may be misaligned). Moreover, the axis A (or axes) may extend in any suitable direction and may facilitate rotation of the bed extender 24 in any rotational direction that facilitates movement of the bed extender 24 between the use position and the stowed position.

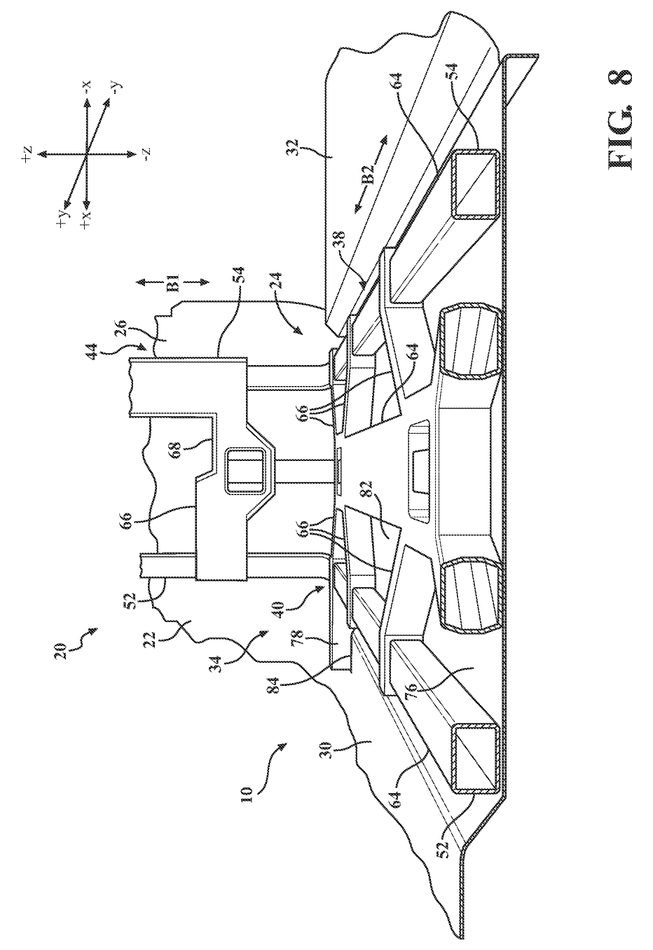

As shown in FIGS. 2 and 6, the floor 30 may define a recess 76 opening into the storage space 34. As shown in FIGS. 3, 5, 7 and 8, the main wall 38 may be disposed in the recess 76 of the floor 30 in the stowed position to allow use of the storage space 34. The recess 76 may be shaped to correspond with and receive the main wall 38 therein. As such, the recess 76 may extend in the vehicle lateral direction Y across the floor 30 between the first bed side wall 26 and the second bed side wall 28 to accommodate the main wall 38 between the first end 40 and the second end 42. Moreover, the recess 76 may extend in the vehicle longitudinal direction X from adjacent the tailgate 32 toward the front of the vehicle 20 a distance that accommodates the main wall 38 between the upper surface 54 and the lower surface 52. The recess 76 may be extend in the vehicle vertical direction Z a distance such that the main wall 38 is at least partially disposed within the recess 76. Referring to FIG. 8, the main wall 38 is partially disposed within the recess 76 such that at least a portion of the main wall 38 extends flush with the floor 30. However, the main wall 38 may be fully disposed within the recess 76 such that the main wall 38 is flush with the floor 30 or disposed below the floor 30. In any configuration, the at least partially disposition of the main wall 38 in the recess 76 allows the main wall 38 to function as a portion of the floor 30, which permits the access and use of the storage space 34.

The mounting of the first rotational joint 56 to the first side wall 44 adjacent the first corner 58 and to the first bed side wall 26 adjacent the tailgate 32 and the top surface of the first bed side wall 26 and the mounting of the second rotational joint 60 to the second side wall 48 adjacent the second corner 62 and to the second bed side wall 28 adjacent the tailgate 32 and the top surface of the second bed side wall 28 allows for the disposition of the main wall 38 in the recess 76 in the stowed position, as shown in FIGS. 3 and 5. More specifically, the disposition of the first corner 58 and the second corner 62 adjacent the tailgate 32 places the upper surface 54 of each of the first side wall 44, the second side wall 48, and the main wall 38 adjacent the tailgate 32, allowing the first side wall 44, the second side wall 48, and the main wall 38 to extend along the first bed side wall 26, the second bed side wall 28, and the floor 30 in the stored position. Moreover, the first rotational joint 56 and the second rotational joint 60 are spaced apart from the floor 30 by being adjacent the top surfaces, allowing the main wall 38 to be disposed along the floor 30. As the bed extender 24 rotates about the first rotational joint 56 and the second rotational joint 60 at the first corner 58 and the second corner 62, respectively, the main wall 38 moves along the floor 30 toward the front of the vehicle 20 without contacting the floor 30, then upwards out of the storage space 34 and down toward the tailgate 32 and into the use position, with the upper surface 54 disposed above the lower surface 52.

As shown in FIG. 1, the bed extender 24 may further include a plurality of legs 78 extending from the lower surface 52 of the main wall 38 and configured to engage the tailgate 32 when the tailgate 32 is in the open position and the bed extender 24 is in the use position. Moreover, the tailgate 32 defines a plurality of pockets 80 individually corresponding to the plurality of legs 78. The plurality of legs 78 extend into the plurality of pockets 80 and engage the tailgate 32 when the tailgate 32 is in the open position and the bed extender 24 is in the use position. In the embodiment shown in FIG. 1, the plurality of legs 78 includes two legs 78 and the plurality of pockets 80 includes two pockets 80 that individually correspond with the two legs 78. However, any number of legs 78 and pockets 80 may be utilized. Each of the pockets 80 may be shaped and sized to individually receive the legs 78 therein and to support the legs 78. More specifically, the pockets 80 engage the legs 78 and support the weight of the bed extender 24 due to gravity. Furthermore, the pockets 80 engage the legs 78 if the bed extender 24 moves in the vehicle longitudinal direction X and/or the vehicle lateral direction Y (e.g., due to loads exerted by the cargo on the bed extender 24 by moving in said directions) to prevent damage to the bed extender 24, loss of the cargo, etc.

The recess 76 may be shaped to accommodate the plurality of legs 78. In the embodiment shown in FIG. 5, the recess 76 includes a primary portion 82 that is shaped and configured to receive the main wall 38 and a plurality of secondary portions 84 that shaped and configured to individually receive the plurality of legs 78. Therefore, the plurality of legs 78 are at least partially disposed within the recess 76, which further prevents intrusion of the legs 78 into the storage space 34. It is to be appreciated that the recess 76 may have any suitable to configuration such that the main wall 38 and the plurality of legs 78 are at least partially disposed therein.

As shown in FIG. 3, the bed extender 24 may further include a pair of handles 86 configured to be grasped by a user for rotating the bed extender 24 between the use position and the stowed position. More specifically, one of the pair of handles 86 may be mounted to the first side wall 44 spaced from the first rotational joint 56 and one of the pair of handles 86 may be mounted to the second side wall 48 spaced from the second rotational joint 60. The spacing of the handles 86 from the first rotational joint 56 and the second rotational joint 60 allow for the user to exert leverage on the bed extender 24 for rotation between the use position and the stowed position. It is to be appreciated that the bed extender 24 may include any number of handles 86 positioned on any suitable portion of the bed extender 24 that may be grasped by the user for rotation between the use position and the stowed position.

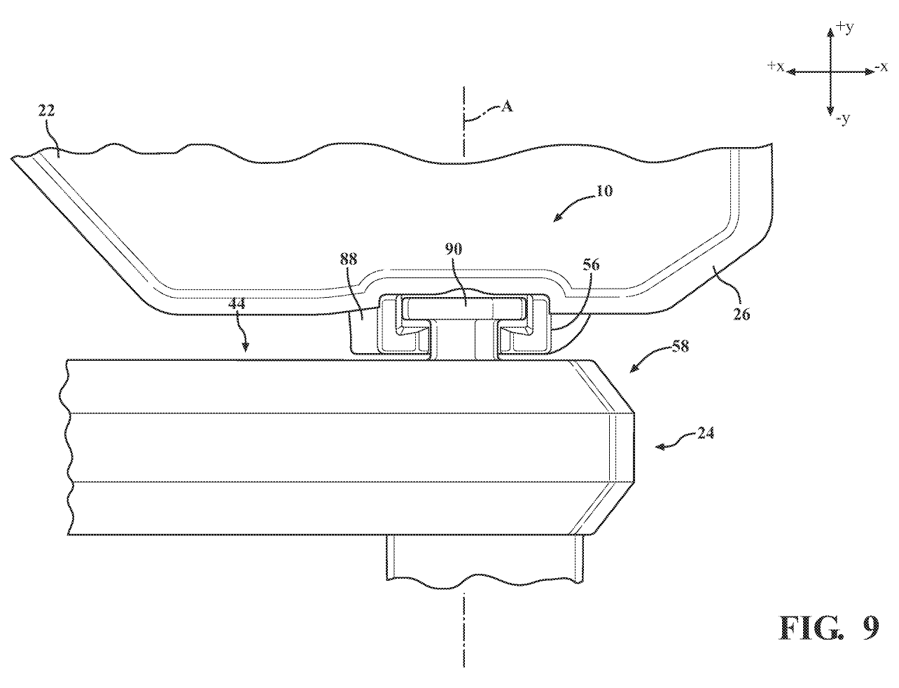

As shown in FIGS. 1-3, each of the first rotational joint 56 and the second rotational joint 60 comprise a receptacle 88 and a stud 90 that engages, and is rotatable relative to, the receptacle 88. The stud 90 of the first rotational joint 56 is mounted to the first side wall 44 and the receptacle 88 of the first rotational joint 56 is mounted to the first bed side wall 26 (see FIG. 9). With reference to FIGS. 1-3, the stud 90 of the second rotational joint 60 is similarly mounted to the second side wall 48 and the receptacle 88 of the second rotational joint 60 is mounted to the second bed side wall 28. In other embodiments, the stud 90 of the first rotational joint 56 may be mounted to the first bed side wall 26, the receptacle 88 of the first rotational joint 56 may be mounted to the first side wall 44, the stud 90 of the second rotational joint 60 may be mounted to the second bed side wall 28, and the receptacle 88 of the second rotational joint 60 may be mounted to the second side wall 48. Moreover, a combination of the above conditions may be utilized (e.g., the stud 90 of the first rotational joint 56 may be mounted to the first side wall 44 and the receptacle 88 of the first rotational joint 56 may be mounted to the first bed side wall 26, while the stud 90 of the second rotational joint 60 may be mounted to the second bed side wall 28 and the receptacle 88 of the second rotational joint 60 may be mounted to the second side wall 48). It is to be appreciated that the first rotational joint 56 and the second rotational joint 60 may have any suitable configuration(s) for allowing rotation between the bed extender 24 and the bed 22.

For simplicity, the description below will refer to the configuration of the stud 90 and the receptacle 88 of the first rotational joint 56, and the interaction therebetween. However, the teachings below may be applied to the stud 90 and the receptacle 88 of the second rotational joint 60.

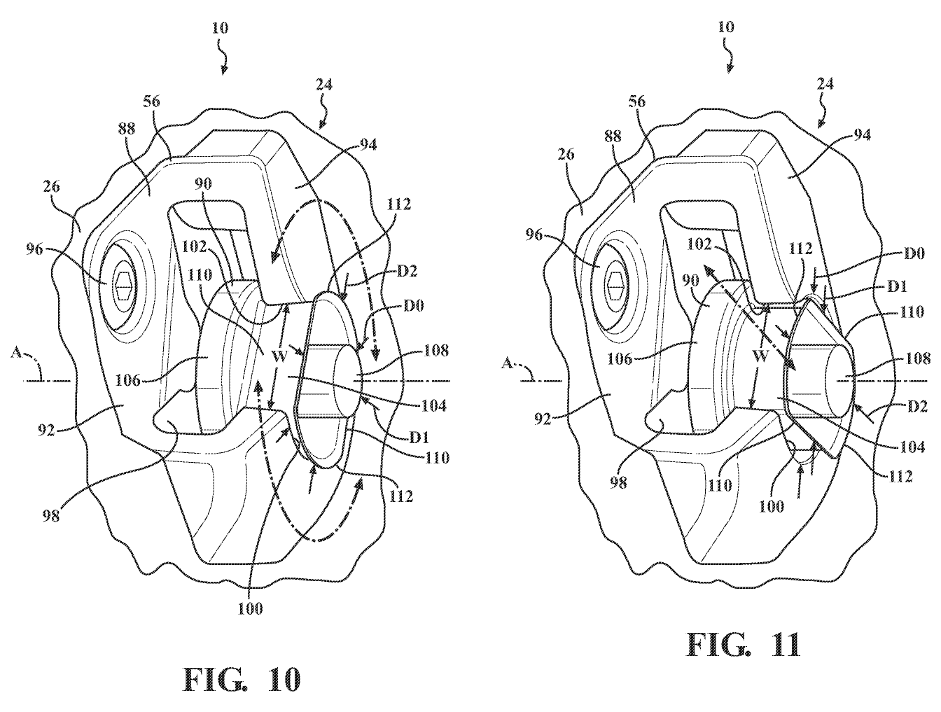

As shown in FIGS. 10 and 11, the receptacle 88 includes a base 92 and an engagement wall 94 extending from the base 92. The base 92 of the receptacle 88 is mounted to the first bed side wall 26 by a fastener 96, but may be mounted to the first bed side wall 26 by welding, chemical bonding, etc. Moreover, the receptacle 88 may be integrally formed with the first bed side wall 26. The base 92 and the engagement wall 94 define a slot 98 therebetween. The receptacle 88 defines a hole 100 and a channel 102 opening into the hole 100. More specifically, the engagement wall 94 of the receptacle 88 defines the hole 100 and the channel 102. The hole 100 extends through the engagement wall 94 along the axis A and opens into the slot 98. The channel 102 extends generally in the vehicle vertical direction Z and is positioned generally above the hole 100.

The stud 90 includes a body 104 that is fixed to the first side wall 44 and a shoulder 106 disposed opposite the first side wall 44 and extending radially beyond the body 104. The stud 90 is mounted to the first side wall 44 by a fastener 108 that engages the shoulder 106 and extends through the body 104 to engage the first side wall 44. However, the stud 90 may be mounted to the first side wall 44 by welding, chemical bonding, etc. The stud 90 is disposed within the hole 100 when assembled with the receptacle 88 and the channel 102 provides passage of the stud 90 into and out of the hole 100 to allow of assembly and disassembly of the stud 90 with the receptacle 88. More specifically, the body 104 of the stud 90 is disposed within the hole 100 when assembled with the receptacle 88 and the channel 102 provides passage of the body 104 into and out of the hole 100 to allow of assembly and disassembly of the stud 90 with the receptacle 88. The shoulder 106 is disposed with the slot 98 and engages the engagement wall 94 around the hole 100 and the channel 102 to prevent the stud 90 from moving along the axis A away from the receptacle 88 and disconnecting form the receptacle 88.

The hole 100 may have a diameter D0 and the channel 102 may have a width W that is less than the diameter D0 for retaining the stud 90 within the hole 100. More specifically, the body 104 of the stud 90 may have an elongated cross-sectional profile having a first dimension D1 and a second dimension D2 that is orthogonal to the first dimension D1. More specifically, the body 104 has a pair of planar surfaces 110 opposite and parallel to one another and a pair of arcuate surfaces 112 opposite one another and extending between the pair of planar surfaces 110. The pair of arcuate surfaces 112 correspond to the diameter D0 of the hole. The first dimension D1 is the distance between the between the pair of planar surfaces 110. The second dimension D2 extends orthogonal to the first dimension D1 between the pair of arcuate surfaces 112 and may be a diameter of the arcuate surfaces 112. The first dimension D1 is less than the second dimension D2.

The first dimension D1 is less than the width W of the channel 102 to allow passage of the stud 90 through the channel 102. Said differently, when the pair of planar surfaces 110 are aligned parallel with the channel 102, the body 104 of the stud 90 may move within the channel 102 to allow passage of the stud 90 through the channel 102 for assembly and disassembly of the stud 90 with receptacle 88 and, more generally, assembly and disassembly of the bed extender 24 with the bed 22. The pair of planar surfaces 110 may be aligned parallel with the channel 102 (see FIG. 11) when the bed extender 24 is disposed in an installation position between the use position and the stowed position (which is shown in FIG. 2). When the bed extender 24 is positioned in the installation position, a user may lift the bed extender 24 in the vehicle vertical direction Z to move the body 104 of the stud 90 through the channel 102 and remove the bed extender 24 from the bed 22. On the other hand, to assemble the bed extender 24 to the bed 22, the user may position the bed extender 24 over the receptacle 88 in the installation position and slide the body 104 of the stud 90 through the channel 102 into the hole 100. As the pair of planar surfaces 110 are only aligned with the channel 102 in the installation position, the engagement of the stud 90 in the receptacle 88 inhibits the bed extender 24 from being removed from the vehicle 20 in the use position and the stowed position.

The second dimension D2 is greater than the width W of the channel 102 and is less than the diameter D0 of the hole 100 to retain the stud 90 in the hole 100 and allow rotation between the stud 90 and the receptacle 88. As such, the stud 90 may rotate freely within the hole 100 between the use position and the stowed position, as shown in FIG. 10. The disposition of the first rotational joint 56 and the second rotational joint 60 above the floor 30 ensures that gravity rotates the bed extender 24 to one of the use position and the stowed position and also maintains the bed extender 24 in said position. Therefore, during normal operation of the vehicle 20, the bed extender 24 is not positioned in the installation position to allow disassembly of the bed extender 24 from the bed 22.

The operation of moving the bed extender 24 from the stowed position to the use position will now be described in detail and with reference to the Figures.

With the bed extender 24 in the stowed position and the tailgate 32 in the closed position, the user moves the tailgate 32 from the closed position (see FIG. 4) to the open position (see FIG. 3). The user grasps the bed extender 24 (e.g., by one or more of the pair of handles 86). The user rotates the bed extender 24 about the axis A (in a clockwise direction when viewed from a left side of the vehicle 20 or in a counter-clockwise direction when viewed from a right side of the vehicle 20). The user continues rotation past the installation position (see FIG. 2). The user continues rotation of the bed extender 24 until the plurality of legs 78 engage the tailgate 32 in the plurality of pockets 80 and the bed extender 24 is in the use position (see FIG. 1).

The operation of moving the bed extender 24 from the use position to the stowed position will now be described in detail and with reference to the Figures.

With the bed extender 24 in the stowed position and the tailgate 32 in the open position (see FIG. 1), the user grasps the bed extender 24. The user rotates the bed extender 24 about the axis A (in a counter-clockwise direction when viewed from the left side of the vehicle 20 or in a clockwise direction when viewed from the right side of the vehicle 20). The user continues rotation past the installation position (see FIG. 2). The user continues rotation of the bed extender 24 until the main wall 38 is at least partially disposed in the recess 76 and is in the stowed position (see FIG. 3). The user may then move the tailgate 32 from the open position (see FIG. 3) to the closed position (see FIG. 4).

It should now be understood that embodiments of the present disclosure are directed to a bed extender assembly for a vehicle having a floor that defines a recess and a pair of bed side walls. The bed extender assembly includes a bed extender having a main wall, a first side wall, and a second side wall. The main wall extends between a first end and a second end. The first side wall extends from the first end of the main side wall and the second side wall extends from the second end of the main wall to define a generally U-shape. The bed extender is rotatably coupled to the pair of bed side walls to rotate between a use position (see FIG. 1) and a stowed position (see FIG. 3). In the stowed position, the main wall is at least partially received within the recess of the floor. In doing so, storage space within the bed is unencumbered, allowing for full use of the bed in the stowed position.

It is noted that the terms "substantially" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A bed extender assembly for a vehicle having a floor that defines a recess and a pair of bed side walls, the bed extender assembly comprising:
a bed extender having a main wall, a first side wall, and a second side wall, the main wall extends between a first end and a second end, the first side wall extends from the first end of the main side wall and the second side wall extends from the second end of the main wall to define a generally U-shape, the bed extender is rotatably coupled to the pair of bed side walls to rotate between a use position and a stowed position, in the stowed position, the main wall is at least partially received within the recess of the floor.

2. The bed extender assembly of claim 1, wherein the first side wall extends from the first end of the main wall to a first distal surface and the second side wall extends from the second end of the main wall to a second distal surface, the main wall, the first side wall, and the second side wall forming a lower surface configured to face a tailgate of the vehicle in the use position and an upper surface opposite the lower surface and configured to face away from the tailgate in the use position.

3. The bed extender assembly of claim 2, further comprising:
a first rotational joint mounted to the first side wall adjacent a first corner defined by the first distal surface and the upper surface; and
a second rotational joint mounted to the second side wall adjacent a second corner defined by the second distal surface and the upper surface, the first rotational joint and the second rotational joint configured to be mounted to a bed of the vehicle and allow rotation of the bed extender relative to the bed between the use position and the stowed position.

4. The bed extender assembly of claim 3, wherein both of the first rotational joint and the second rotational joint are disposed along, and rotatable about, an axis.

5. The bed extender assembly of claim 3, wherein each of the first rotational joint and the second rotational joint comprise a receptacle and a stud that engages, and is rotatable relative to, the receptacle.

6. The bed extender assembly of claim 5, wherein the receptacle defines a hole and a channel opening into the hole, the stud being disposed within the hole when assembled with the receptacle and the channel providing passage of the stud into and out of the hole to allow of assembly and disassembly of the stud with the receptacle.

7. The bed extender assembly of claim 6, wherein the hole has a diameter and the channel has a width that is less than the diameter for retaining the stud within the hole.

8. The bed extender assembly of claim 7, wherein the stud has an elongated cross-sectional profile having a first dimension and a second dimension that is orthogonal to the first dimension, the first dimension being less than the second dimension, the first dimension being less than the width of the channel to allow passage of the stud through the channel, and the second dimension being greater than the width of the channel and less than the diameter of the hole to retain the stud in the hole and allow rotation between the stud and the receptacle.

9. The bed extender assembly of claim 1, wherein both the first side wall and the second side wall extend from the main wall in a first direction, and the main wall extends in a second direction that is orthogonal to the first direction.

10. The bed extender assembly of claim 1, wherein each of the first side wall and the second side wall have a planar configuration and are disposed parallel to one another.

11. The bed extender assembly of claim 1, wherein the main wall, the first side wall, and the second side wall have a space frame configuration.

12. A vehicle comprising:
a bed comprising:
a pair of bed side walls each extending in a vehicle vertical direction; and
a floor extending in a vehicle lateral direction between the pair of bed side walls, the floor and the pair of bed side walls defining a storage space, the floor defining a recess opening into the storage space; and
a bed extender assembly comprising:
a bed extender having a main wall, a first side wall, and a second side wall, the main wall extends between a first end and a second end, the first side wall extends from the first end of the main side wall and the second side wall extends from the second end of the main wall to define a generally U-shape, the bed extender is rotatably coupled to the pair of bed side walls to rotate between a use position and a stowed position, in the stowed position, the main wall is at least partially received within the recess of the floor.

13. The vehicle of claim 12, further comprising a tailgate coupled to the floor of the bed and moveable between an open position in which the tailgate is coplanar with the floor and a closed position in which the tailgate to transverse to the floor.

14. The vehicle of claim 13, wherein the first side wall and the second side wall are rotatably mounted to the pair of bed side walls, adjacent the tailgate.

15. The vehicle of claim 13, further comprising a plurality of legs extending from the main wall and configured to engage the tailgate when the tailgate is in the open position and the bed extender is in the use position.

16. The vehicle of claim 15, wherein the tailgate defines a plurality of pockets individually corresponding to the plurality of legs, the plurality of legs extending into the plurality of pockets and engaging the tailgate when the tailgate is in the open position and the bed extender is in the use position.

17. The vehicle of claim 12, wherein the first side wall extends from the first end of the main wall to a first distal surface and the second side wall extends from the second end of the main wall to a second distal surface, the main wall, the first side wall, and the second side wall forming a lower surface configured to face a tailgate of the vehicle in the use position and an upper surface opposite the lower surface and configured to face away from the tailgate in the use position.

18. The vehicle of claim 17, wherein the bed extender assembly further comprises:
a first rotational joint mounted to the first side wall adjacent a first corner defined by the first distal surface and the upper surface; and
a second rotational joint mounted to the second side wall adjacent a second corner defined by the second distal surface and the upper surface, the first rotational joint and the second rotational joint configured to be mounted to the pair of bed side walls and allow rotation of the bed extender relative to the bed between the use position and the stowed position.

19. The vehicle of claim 12, wherein both the first side wall and the second side wall extend from the main wall in a first direction and the main wall extends in a second direction that is orthogonal to the first direction.

20. A vehicle comprising:
a bed comprising:
a first bed side wall and a second bed side wall each extending in a vehicle vertical direction; and
a floor extending in a vehicle lateral direction between the first bed side wall and the second bed side wall;
a tailgate coupled to the floor of the bed and moveable between an open position in
which the tailgate is coplanar with the floor and a closed position in which the tailgate to
transverse to the floor; and
a bed extender assembly comprising:
a bed extender rotatable between a use position and a stowed position when the
tailgate is in the open position, the bed extender comprising:
a main wall extending between a first end and a second end;
a first side wall extending from the first end of the main wall to a first distal surface; and
a second side wall extending from the second end of the main wall to a
second distal surface, wherein the main wall, the first side wall, and the second
side wall form a lower surface configured to face the tailgate of the vehicle in
the use position and an upper surface opposite the lower surface and configured
to face away from the tailgate in the use position;
a first rotational joint mounted to the first side wall adjacent a first corner
defined by the first distal surface and the upper surface and mounted to the first bed
side wall of the bed; and
a second rotational joint mounted to the second side wall adjacent a second
corner defined by the second distal surface and the upper surface and mounted to the
second bed side wall of the bed, the first rotational joint and the second rotational joint
allowing rotation of the bed extender relative to the bed between the use position and
the stowed position,
wherein the first bed side wall, the second bed side wall, and the floor define a storage
space and the floor defines a recess opening into the storage space, the main wall disposed in
the recess of the floor in the stowed position to allow use of the storage space.
